(19) United States
(12) Patent Application Publication
(10) Pub. No.: US 2025/0271646 A1
(43) Pub. Date: Aug. 28, 2025

(54) SURROUND VIEWING USING A FISHEYE LENS AND ONE OR MORE WEDGE PRISMS

(71) Applicant: PRIZM OPTICS PTE. LTD., Singapore (SG)

(72) Inventor: Mark BREESE, Singapore (SG)

(73) Assignee: PRIZM OPTICS PTE. LTD., Singapore (SG)

(21) Appl. No.: 18/858,072

(22) PCT Filed: Mar. 14, 2023
(86) PCT No.: PCT/SG2023/050164

§ 371 Date: Oct. 18, 2024

(30) Foreign Application Priority Data
Apr. 21, 2022 (SG) 10202204192V

(51) Int. Cl. G02B 13/06; G02B 5/04; G03B 37/00; H04N 23/55

(52) U.S. Cl. CPC G02B 13/06; G02B 5/04; G03B 37/00; H04N 23/55

(57) ABSTRACT

An optical device and a method of extending a field of view of an optical device comprising a fisheye lens configured to provide a substantially 360° azimuthal angle view with a forward direction at 0° radial angle and with a maximum radial angle θₘ, and a sensor configured to record an image through the fisheye lens. The method comprises the step of disposing one or more wedge prisms adjacent the fisheye lens, wherein each of the one or more prisms is configured such that a ray incident at more than θₘ radial angle is deflected to be captured through the fisheye lens onto the sensor.

### FIELD OF INVENTION

The present invention relates broadly to an optical device and to a method of extending a field of view of an optical device comprising a fisheye lens.

### BACKGROUND

There are a range of current and desired applications of fisheye cameras operating in the visible and near-infrared regions of the electromagnetic spectrum in which they are oriented vertically in order to record a full 360° azimuthal view of sideways-oriented features. For example when mounted on a helmet of a motorbike, FIG. 1, or a bicyclist, or as a surround view video conference device. There are other applications of miniature fisheye cameras where this viewing geometry is desired, such as endoscopes, but is not yet currently possible owing to difficulties in manufacturing suitable fisheye lenses and small sensors with sufficient number of pixels.

FIG. 2 illustrates the coordinate system used. Two angles are important to define; first, the radial angle θ away from the forward direction in which a camera lens (this being a fisheye lens) is oriented. Second, the azimuthal angle, where around the circumference of the forward hemisphere with the camera lens at the centre describes a complete ϕ=360° view. One way of classifying different types of fisheye lenses is their angular range captured on the sensor in two orthogonal directions. Most sensors are rectangular, being designed to record a rectangular field of view i.e. a wider view in the horizontal plane than in the vertical plane. FIG. 3a shows a circular fisheye view in which the full image circle with a radial angle of 90° away from the forward direction (compare FIG. 2) is recorded in both horizontal and vertical directions, allowing recording of a full ϕ=360° azimuthal view 300. However, the drawback is that there are significant areas of the sensor 302 which are not used, so limiting the recorded view in angular resolution. In FIG. 3b, for same circular fisheye view, the radial angle of 90° in the horizontal direction extends over the full width of the smaller sensor 304, making better use of available pixels for recording. However, in the vertical direction the full 90° radial tilt range is not recorded (compare exceeding view portions 306, 308) and so one cannot view around the full 360° azimuth at θ=90°. This is typically the case when smaller sensors 304 are used with a fisheye lens. In the full frame fisheye view in FIG. 3c, the sensor 312 is even smaller so even the horizontal direction does not record the full 90° radial tilt range (see additional exceeding view portions 314, 316. This is the situation typically used on very small sensors 312 as would have to be used in endoscopes.

There are several problems with current fisheye lens based approaches:

There are increasing optical aberrations inherent in the recorded view beyond radial angles of about 80°, illustrated in FIG. 4a. This can lead to blurring and colour distortion around the azimuthal view at the maximum recorded radial angle, being θ=90° in FIG. 4a.

In addition, most of the central portion of the sensor records views from small radial angles, i.e. “upwards” in FIGS. 1 and 2, which are not required or useful in many applications where the aim is 360° azimuthal viewing.

Also, much of the outer portion of the sensor of a circular fisheye is often not used as illustrated in FIG. 3a, so in total only a small portion of the sensor area records useful information of the 360° azimuthal view.

It is also noted that a maximum radial angle of 90° does not allow viewing below the horizontal plane of the fisheye camera. One might use a fisheye lens with an even larger radial viewing angle, say up to 110° (giving a full radial viewing range of 220° around the forward direction of the fisheye lens); however, the above problems are exacerbated, i.e. the outer sensor being unused, the inner sensor conveying no useful information and a larger sensor needed to record the full radial extent of the view.

Therefore there are clear limitations in current approaches which use fisheye lenses and sensors for 360° surround (azimuthal) viewing, with limitations in clarity, pixel resolution and maximum radial viewing angle, wasted sensor area and the need to use large sensors.

Embodiments of the present invention seek to address at least one of the above problems.

### SUMMARY

In accordance with a first aspect of the present invention, there is provided an optical device comprising:

a fisheye lens configured to provide a substantially 360° azimuthal angle view with a forward direction at 0° radial angle and with a maximum radial angle θₘ;

a sensor configured to record an image through the fisheye lens; and one or more wedge prisms disposed adjacent the fisheye lens and each configured such that a ray incident at more than θₘ radial angle is deflected to be captured through the fisheye lens onto the sensor.

The sensor may be rectangular and the one or more wedge prisms may be configured such that each of a horizontal angular range and a vertical angular range of the recorded image is +/−θₘ extending over substantially the full horizontal and vertical axes, respectively, of the sensor.

The one or more wedge prisms may comprise right angle wedge prisms with a sloped face of the right angle wedge prism facing outwards from the fisheye lens.

The one or more wedge prisms may comprise right angle wedge prisms with a vertical face of the right angle wedge prism facing outwards from the fisheye lens.

The one or more wedge prisms may comprise isosceles wedge prisms with one of the shallow sloped faces of the isosceles wedge prism facing outwards from the fisheye lens.

The one or more wedge prisms may each comprise angled extension portions on either side thereof, and three or more such wedge prisms may be disposed around the fisheye lens to direct rays from the substantially full 360° azimuthal angle view through the fisheye lens onto the sensor.

The one or more wedge prisms may comprise a conical wedge prism or portions thereof.

The one or more wedge prisms may comprise one full conical wedge prism, two half-conical wedge prisms, or four quarter-conical wedge prisms disposed around the fisheye lens to direct rays from the substantially full 360° azimuthal angle view through the fisheye lens onto the sensor. The one or more wedge prisms may comprise two wedge prisms such that rays incident at more than Om radial angle from two opposing sides of the substantially full 360° azimuthal angle view are deflected to be captured through the fisheye lens onto the sensor. The two wedge prisms may comprise quarter-conical wedge prisms. In accordance with a second aspect of the present invention, there is provided a method of extending a field of view of an optical device comprising a fisheye lens configured to provide a substantially 360° azimuthal angle view with a forward direction at 0° radial angle and with a maximum radial angle Om, and a sensor configured to record an image through the fisheye lens, the method comprising the step of:

disposing one or more wedge prisms adjacent the fisheye lens, wherein each of the one or more prisms is configured such that a ray incident at more than Om radial angle is deflected to be captured through the fisheye lens onto the sensor.

The sensor may be rectangular and the one or more wedge prisms may be configured such that each of a horizontal angular range and a vertical angular range of the recorded image is +/−θₘ extending over substantially the full horizontal and vertical axes, respectively, of the sensor.

The method may comprise disposing one or more right angle wedge prisms with a sloped face of the right angle wedge prism facing outwards from the fisheye lens.

The method may comprise disposing one or more right angle wedge prisms with a vertical face of the right angle wedge prism facing outwards from the fisheye lens.

The method may comprise disposing one or more isosceles wedge prisms with one of the shallow sloped faces of the isosceles wedge prism facing outwards from the fisheye lens.

The one or more wedge prisms may each comprise angled extension portions on either side thereof, and the method may comprise disposing three or more such wedge prisms around the fisheye lens to direct rays from the substantially full 360° azimuthal angle view through the fisheye lens onto the sensor.

The one or more wedge prisms may comprise a conical wedge prism or portions thereof.

The method may comprise disposing one full conical wedge prism, two half-conical wedge prisms, or four quarters-conical wedge prisms around the fisheye lens to direct rays from the substantially full 360° azimuthal angle view through the fisheye lens onto the sensor. The method may comprise disposing two wedge prisms such that rays incident at more than Om radial angle from two opposing sides of the substantially full 360° azimuthal angle view are deflected to be captured through the fisheye lens onto the sensor. The two wedge prisms may comprise quarter-conical wedge prisms.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic drawing illustrating a fisheye lens mounted on a helmet of a motorbike.

FIG. 2 illustrates the coordinate system used in the present application. Two angles are important to define; first, the radial angle θ away from the forward direction in which a camera lens (this being a fisheye lens) is oriented. Second, the azimuthal angle, where around the circumference of the forward hemisphere with the camera lens at the centre describes a complete ϕ=360° view.

FIG. 3a shows a schematic drawing illustrating an image views captured by a sensor through a fisheye lens in one example.

FIG. 3b shows a schematic drawing illustrating an image views captured by a sensor through a fisheye lens in another example.

FIG. 3c shows a schematic drawing illustrating an image views captured by a sensor through a fisheye lens in another example.

FIG. 4a shows a schematic drawing illustrating a radial viewing angle of a fisheye lens.

FIG. 4b shows a schematic drawing illustrating a radial viewing angle of a fisheye lens with a standard 25° wedge prism located to one side of the same fisheye lens, according to an example embodiment.

FIG. 5 shows photographs illustrating a comprising of a radial viewing angle of a fisheye lens and of a fisheye lens with a standard 25° wedge prism located to two sided of the same fisheye lens, according to an example embodiment.

FIG. 6a shows a photograph illustrating a radial viewing angle of a fisheye lens.

FIG. 6b shows a photograph illustrating a radial viewing angle of a fisheye lens with a standard 25° wedge prism located to two sides of the same fisheye lens, according to an example embodiment.

FIG. 7a shows a schematic drawing illustrating the geometry of a fisheye lens with a standard 40° wedge prism located to one side of a fisheye lens, according to an example embodiment.

FIG. 7b shows a schematic drawing illustrating the geometry of a fisheye lens with an isosceles wedge prism located to one side of a fisheye lens, according to an example embodiment.

FIG. 7c shows a schematic drawing illustrating the geometry of a fisheye lens with a right angle wedge prism located to one side of a fisheye lens with the vertical face outward, according to an example embodiment.

FIG. 8 shows photographs illustrating a comprising of a radial viewing angle of a fisheye lens and of a fisheye lens with a standard 25° wedge prism located to two sided of the same fisheye lens, according to an example embodiment.

FIG. 9a shows a photograph illustrating a radial viewing angle of a fisheye lens.

FIG. 9b shows a photograph illustrating a radial viewing angle of a fisheye lens with a standard 25° wedge prism located to two sides of the same fisheye lens, according to an example embodiment.

FIG. 10a shows a photograph of the geometry of a fisheye lens with 4 right angle wedge prisms located to each side of a fisheye lens with the sloped face outward, according to an example embodiment.

FIG. 10b shows a schematic drawing illustrating the geometry of a fisheye lens with 4 right angle wedge prisms located to each side of a fisheye lens with the sloped face outward, according to an example embodiment.

FIG. 11a shows a schematic drawing illustrating the geometry of a fisheye lens with 4 right angle wedge prisms located to each side of a fisheye lens with the sloped face outward and with perpendicular sides, according to an example embodiment.

FIG. 11b shows a schematic drawing illustrating the geometry of a fisheye lens with 4 right angle wedge prisms located to each side of a fisheye lens with the sloped face outward and with angled/extended sides, according to an example embodiment.

FIG. 11c shows a schematic drawing illustrating the geometry of a fisheye lens with 4 right angle wedge prisms located to each side of a fisheye lens with the sloped face outward and with angled/extended sides for substantially complete ϕ=360° view, according to an example embodiment.

FIG. 11d shows a schematic drawing illustrating the geometry of a fisheye lens with 3 right angle wedge prisms located to each side of a fisheye lens with the sloped face outward and with angled/extended sides for substantially complete ϕ=360° view, according to an example embodiment.

FIG. 12a shows a schematic drawing illustrating a conical prism.

FIG. 12b shows a schematic drawing illustrating a conical wedge prism with sloped inner face, for use in example embodiments.

FIG. 12c shows a schematic drawing illustrating a conical wedge prism with perpendicular inner face, for use in example embodiments.

FIG. 12d shows a schematic drawing illustrating a conical wedge prism with isosceles geometry, for use in example embodiments.

FIG. 12e shows a schematic drawing illustrating a conical wedge prism with vertical outer face, for use in example embodiments.

FIG. 13a shows a schematic drawing illustrating a fisheye lens with housing, for use in example embodiments.

FIG. 13b shows a schematic drawing illustrating a conical wedge prism, for use in example embodiments.

FIG. 13c shows a schematic drawing illustrating an assembled optical device, according to an example embodiment.

FIG. 14a shows a photograph of a conical wedge prism and a fisheye lens with housing, for use in example embodiments.

FIG. 14b shows a photograph of an assembled optical device, according to an example embodiment.

FIG. 15a shows a plot illustrating the radial view of a fisheye lens.

FIG. 15b shows a plot illustrating the radial view of an optical device according to an example embodiment.

FIG. 16a shows a plot illustrating capturing the radial view of a fisheye lens on a sensor.

FIG. 16b shows a plot illustrating capturing the radial view of an optical device according to an example embodiment.

FIG. 17a shows a schematic drawing illustrating a conical wedge prism, for use in example embodiments.

FIG. 17b shows a schematic drawing illustrating two half conical wedge prisms, for use in example embodiments.

FIG. 17c shows a schematic drawing illustrating two quarter conical wedge prisms, for use in example embodiments.

FIG. 18a shows a schematic drawing illustrating the radial view of an optical device according to an example embodiment.

FIG. 18b shows a schematic drawing illustrating the radial view of an optical device according to an example embodiment.

FIG. 19a shows a plot illustrating capturing the radial view of a fisheye lens on a sensor.

FIG. 19b shows a plot illustrating capturing the radial view of an optical device according to an example embodiment.

FIG. 20 shows schematic drawings illustrating an optical device on a helmet for a motorbike, according to an example embodiment.

FIG. 21 shows schematic drawings illustrating an optical device on a helmet for a motorbike, according to an example embodiment.

FIG. 22 shows a schematic drawing illustrating the radial view of an optical device on a helmet on a motorbike, according to an example embodiment.

FIG. 23 shows schematic drawing illustrating a comparison of the radial view of an existing video conference camera and an optical device in the form of a video conference camera, according to an example embodiment.

FIG. 24 shows a schematic drawing illustrating an application scenario for an optical device according to an example embodiment.

FIG. 25a shows a schematic drawing illustrating an application scenario for an optical device according to an example embodiment.

FIG. 25b shows a schematic drawing illustrating an application scenario for an optical device according to an example embodiment.

FIG. 26a shows a schematic drawing an optical device according to an example embodiment.

FIG. 26b shows a schematic drawing illustrating an application scenario for the optical device of FIG. 26a.

FIG. 27a shows a schematic drawings illustrating a stereo vision optical device according to an example embodiment.

FIG. 27a shows a schematic drawings illustrating a radial view of a stereo vision optical device according to an example embodiment.

### DETAILED DESCRIPTION

Embodiments of the present invention provide for the use of fisheye lens arrangements allowing the maximum radial field of view to be increased, for example by 25°, so that the maximum radial angle can be increased from 90 to 115°, or, where the radial viewing angle is less than 90° for small sensors, it can be increased to about 90°, allowing sideways viewing even with very small sensors.

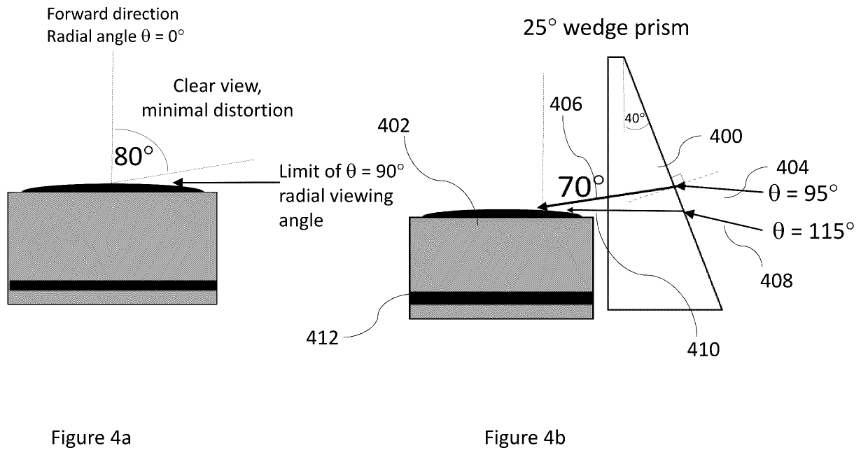

With reference to FIG. 4b, which shows a standard 25° wedge prism 400 located to one side of the same fisheye lens 402 as in FIG. 4a. Note that the angle of 25° here refers to the angle by which light is deflected in passing through the wedge prism 400, while the corresponding geometric tilt angle of the sloping surface of the wedge prism 400 is larger than this, typically 40°, depending on the refractive index of the glass or plastic material used. The wedge prism 400 deflects light entering at large radial angles to smaller radial angles, so for example, a ray 404 incident from the right at a radial angle of 95° exits it on the left surface at a radial angle of 70°, indicated at numeral 406. Furthermore, now a ray 408 incident at a radial angle of 115° falls on the fisheye at a radial angle of 90°, indicated at numeral 410, and so is recorded. The effect is thus to extend the radial angle which is recorded on the sensor 412 of a given size. Furthermore, the clarity of the view recorded at the original maximum radial extent may be improved.

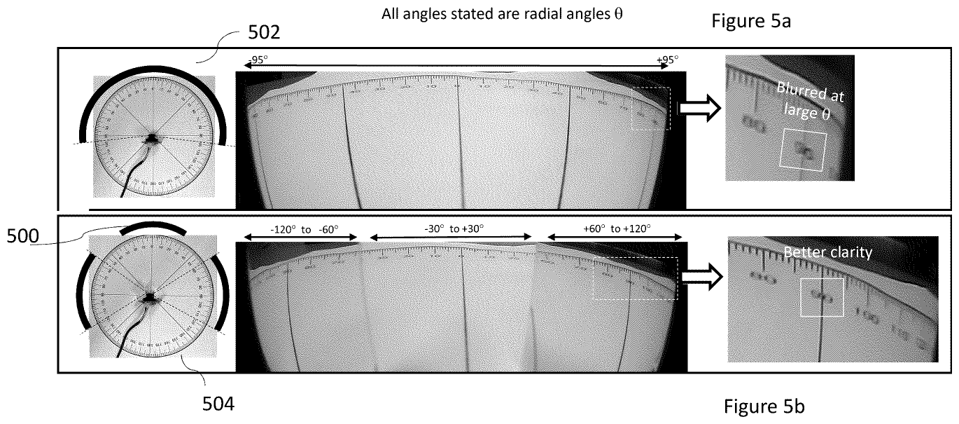

FIG. 5a shows the view recorded by a fisheye lens with a maximum radial viewing angle of about 95° (190° full angle with respect to the forward direction). FIG. 5b shows the same lens but with standard 25° wedge prisms placed at either side of the fisheye lens, with the sloping face outwards. There are several points to note:
The maximum radial viewing angle is extended by the wedge prism to 95°+25°=120°, compare FIGS. 5a and b.
The clarity of the view at a radial angle of 90° to 95° (i.e. the original maximum radial extent) improves significantly in FIG. 5b compared to FIG. 5a. This can be clearly seen in the expanded views at the far right, from within the dashed boxes in the main view.
The view at small radial angles, indicated at numeral 500 in FIG. 5b, is unaffected by the adjacent wedge prisms as this angular range does not pass through the wedge prisms. The angular extent of the unaffected central region depends on the distance of the wedge prisms from the lens and their height, i.e. just geometrical considerations of whether the prism intercepts rays or not.

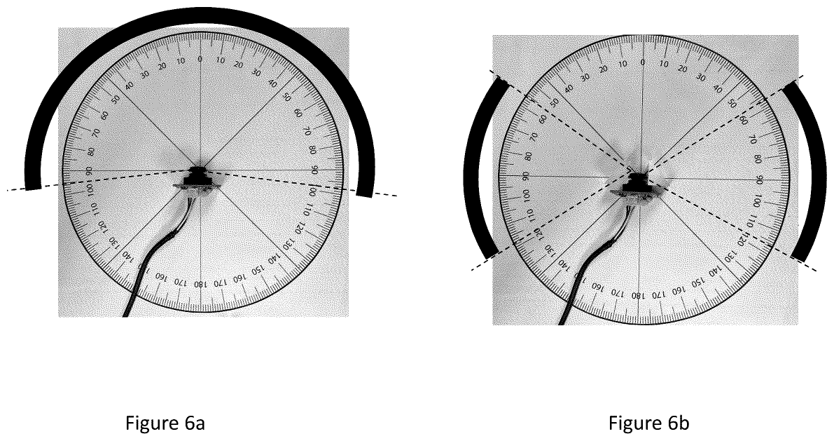

FIGS. 6a and b show enlarged versions of the images 502 and 504 in FIGS. 5a and b with the viewing ranges indicated by the black lines.

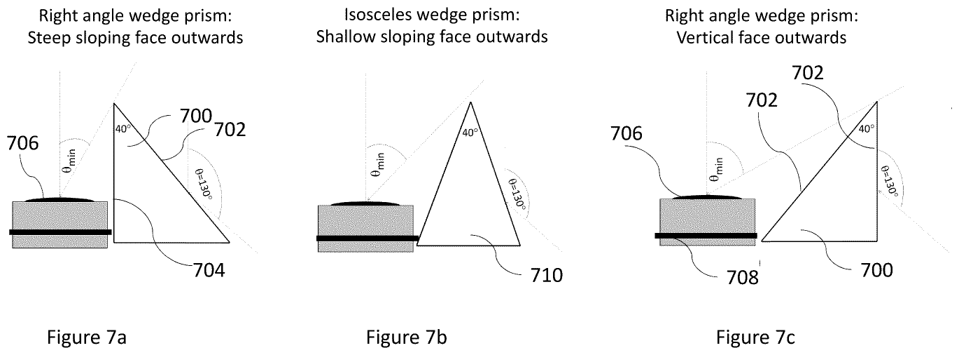

FIG. 7a shows the above described orientation (compare FIGS. 4b, 5b, and 6b) where the wedge prism 700 sloping face 702 is outwards. This means that very large radial angles are incident at a very shallow angle to the sloping face 702 (a radial angle of 130° is indicated in FIG. 7a), resulting in a limitation in the maximum radial angle that can be deflected into the fisheye camera, see FIG. 5b, 6b, where the maximum is about 120°. Since the vertical face 704 is close to the lens 706 then the minimum radial angle passing through the upper portion of the wedge prism 700 is about 60°. Thus the range of viewing angles passing through the wedge prism 700 in this orientation is from +/−60° to +/−120°, giving a range of 2×60°.

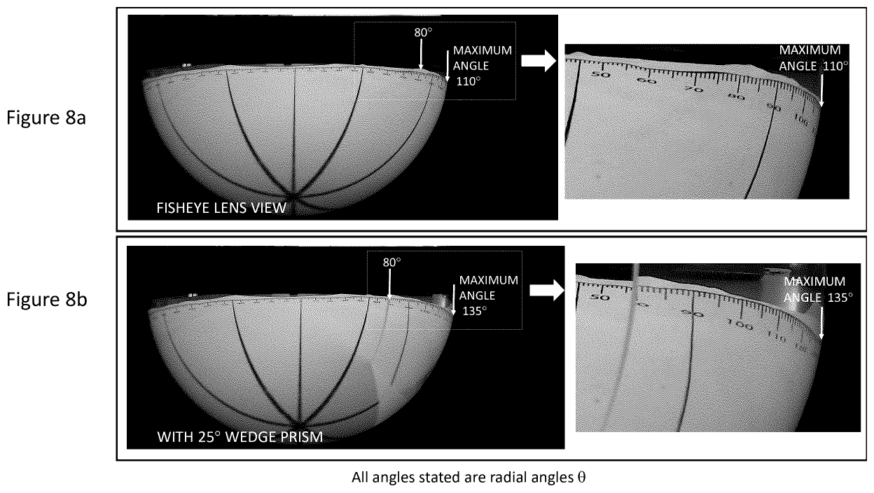

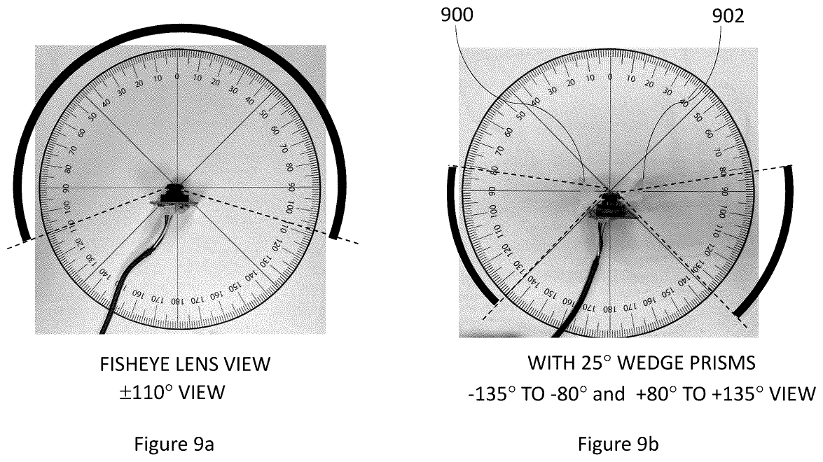

FIG. 7c shows the same wedge prism 700 oriented with the sloping face 702 inwards and the vertical face 704 is outwards. Now, very large radial angles are incident on the vertical face at larger angles (a radial angle of 130° is again indicated in FIG. 7a) so they are less limited in passing through the wedge prism 700 and being recorded on the fisheye lens 706 and onto the sensor 708. An example of this is shown in FIGS. 8 and 9 where the maximum radial angle of 110° of the fisheye lens without a prism (FIG. 8a, 9a) is increased to 135° (i.e. deflected by 25° through the wedge prisms 900, 902) and recorded by the maximum radial acceptance of 110° of the fisheye lens. However, now the minimum radial angle which can pass through the wedge prisms 900, 902 is significantly larger, being limited to about 80° in FIG. 8b, 9b). Thus the range of viewing angles passing through the wedge prisms 900, 902 in this orientation is from +/−80° to +/−135°, giving a range of 2×55°.

FIG. 7b shows the same geometric angle of 40° between the entrance and exit faces of the wedge prism as in FIG. 7a,c but now the geometry is that of an isosceles prism 710, having intermediate properties of maximum and minimum radial acceptance angle.

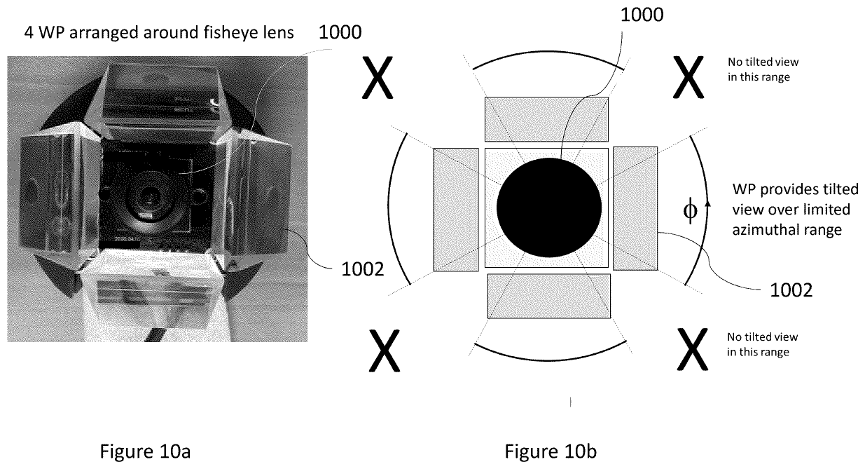

FIG. 10a shows a plan view of a fisheye lens 1000 surrounded by four standard wedge prisms (WP) e.g. 1002. Each one prism e.g. 1002 deflects the radial view within a certain azimuthal angular range. However, not all azimuthal angles are deflected since there are large gaps between adjacent wedge prisms where incoming rays do not suitably pass through a wedge prism to be recorded, as denoted by the X symbols in FIG. 10b. Each wedge prism e.g. 1002 typically can accept an azimuthal angular range of about 60°, leaving significant gaps of about 30° between adjacent prisms.

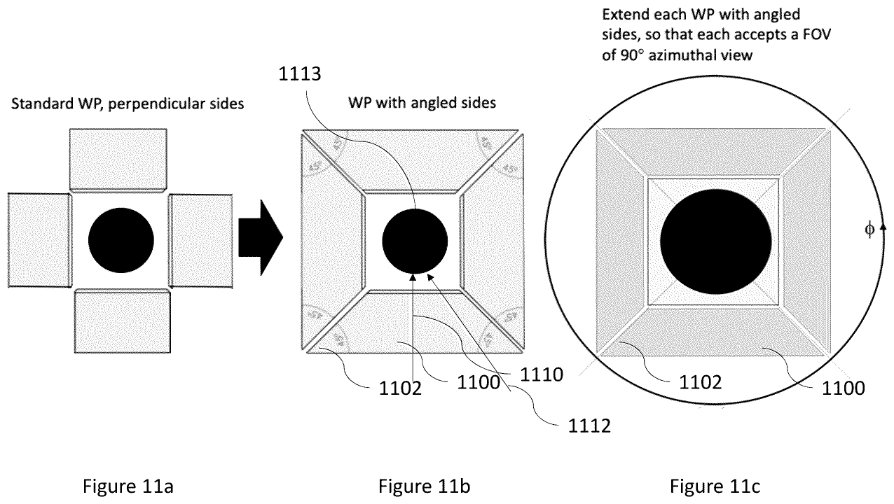

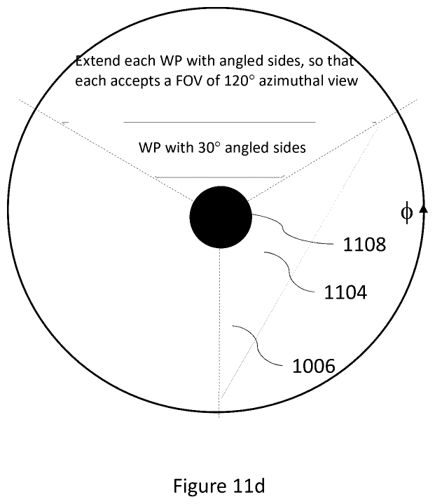

FIG. 11b shows how this problem can be addressed by wedge prisms e.g. 1100 with extended side portions e.g. 1102 at angles of 45°, allowing adjacent wedge prisms e.g. 1100 to be located with their side walls touching each other. Each prism e.g. 1100 in the continuous structure can now accept an azimuthal angular range of 90°, allowing a more complete 360° azimuthal view to be formed using the four angled wedge prisms, as also shown in FIG. 11c. Other combinations are possible, such as three wedge prims e.g. 1104 with extended side portions e.g. 1106 angled at 60° located in a triangular manner around the fisheye lens 1108, as shown in FIG. 11d.

The example embodiments described above have the virtue of using linear wedge prisms with different orientations and geometries, see e.g. FIG. 7, which may feature extended side walls, see FIG. 11. While these geometries are straightforward to manufacture, one drawback is that the lens/prism distance and orientation varies with azimuthal angle. Taking e.g. FIG. 11b, in the centre of the wedge prism 1100 rays e.g. 1110 enter perpendicular to the (in this example sloped) entry surface and they exit the exit surface where it is closest to the lens 1113, whereas away from the middle rays e.g. 1112 enter at inclined angles to the entry surface and exit the exit surface where it is further away from the lens 1113. While such curvature can be mostly software corrected where necessary, a new conical wedge prism geometry which provides a uniform prism-lens alignment around the full 360° azimuthal view is described below, according to another example embodiment.

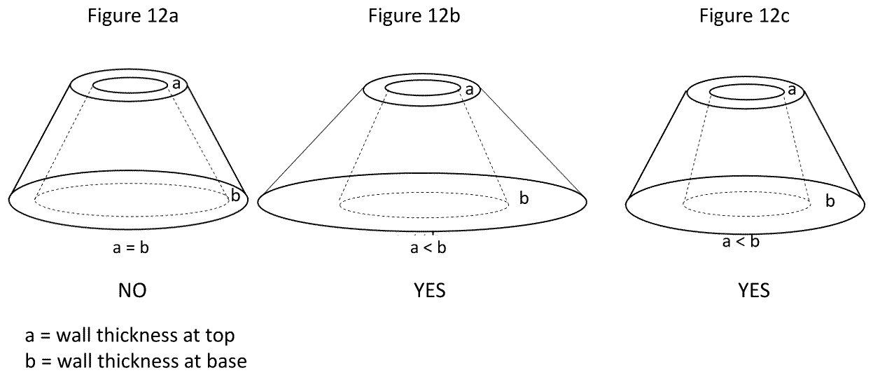

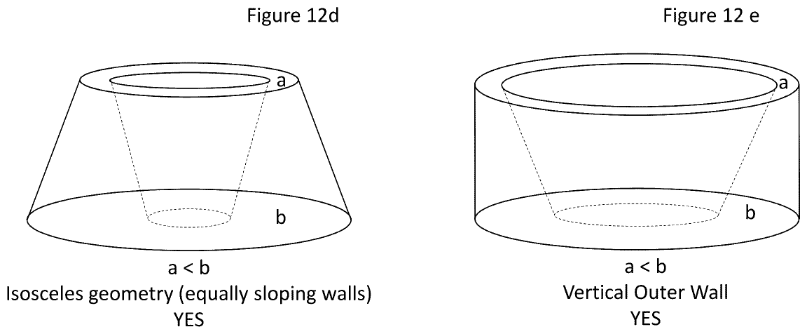

In FIG. 12 the top portion of a hollow, transparent cone is removed. In FIG. 12a the wall thickness of the cone 1200 is uniform, i.e. wall thickness a at top=wall thickness b at base, so this geometry does not act as a wedge prism in deflecting large radial angles to smaller ones. In FIG. 12b the wall thickness of the cone 1202 increases from top to bottom (a<b) giving a wedge prism effect, with the inner wall tilted. This example geometry is best suited to where smaller radial angles are required to be included in the deflected portions, since the tilted inner surface means that it may extend over the fisheye lens, and where the maximum radial viewing angle (with reduced blurring and/or color distortion) is desired to be around 90°. In the example in FIG. 12c the wall thickness of the cone 1204 again increases from top to bottom (a<b) which gives an effect similar to that in FIG. 4b where the exit prism surface is vertical. There are other examples where the dimension “a” may be very small, this has no detrimental effect on the light which is deflected though the conical wedge prism according to an example embodiment, while minimizing the angular boundary between the deflected portions and large radial angles and the undeflected portions at small radial angles.

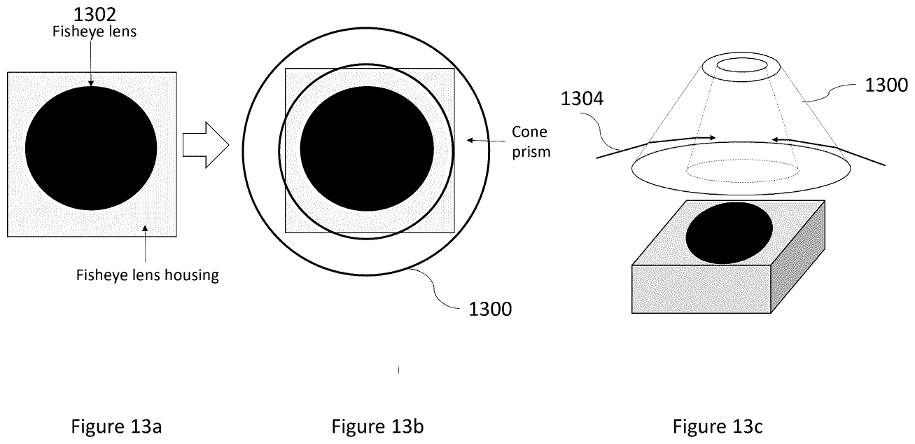

The correct terminology for this truncated cone geometry in FIGS. 12b and 12c is a hollow frustum but for simplicity it is herein referred to as a conical wedge prism, or cone prism. FIGS. 12d,e show other conical wedge prisms of a geometry corresponding respectively to FIGS. 7b,c. Other geometries between those shown in FIG. 12b to e have a similar effect and can be used in example embodiments. FIG. 13 shows how a conical wedge prism 1300 is located over a fisheye lens 1302, allowing a complete azimuthal 360° to be viewed with no change in prism/lens geometry. Now large angle radial rays e.g. 1304 are deflected to smaller angles in a uniform manner around the full 360° azimuthal view.

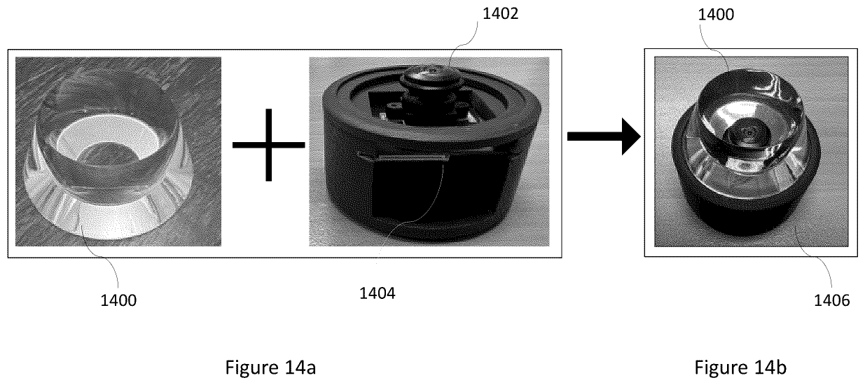

The photographs in FIG. 14a show how a cone prism 1400 and fisheye lens 1402 which is mounted on a camera sensor 1404 are combined together in practice, FIG. 14b, to produce the final optical geometry/optical device 1406. The cone prism shown in FIGS. 14a and b has an isosceles profile, similar to FIG. 12d, but with “a” being very small. The central portion of the view may be recorded or blanked off by a separate plate (not shown) placed over the top of the cone prism 1400, depending on the required application.

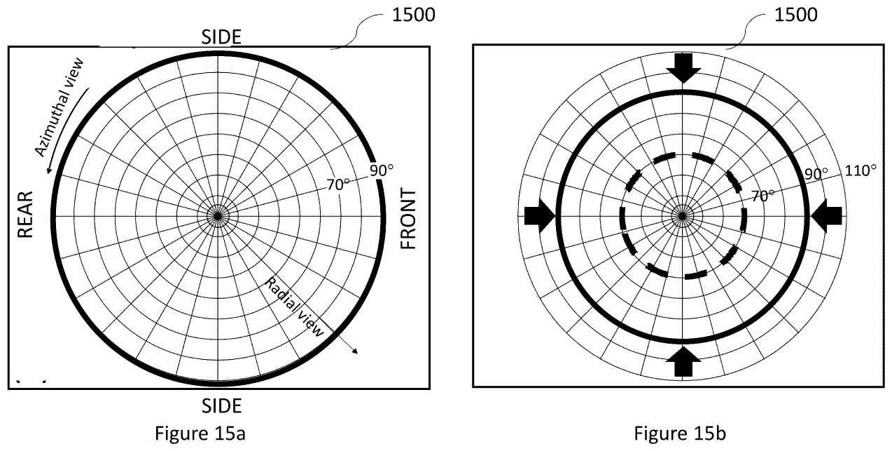

FIG. 15a shows a polar plot of a circular fisheye lens providing a 360° azimuthal view, bounded by 90° radial maximum, black solid line. In FIG. 15b a conical wedge prism provides a 20° radial inwards tilt of the view around full 360° azimuth. The 90° radial view line azimuth is now deflected closer to the view centre (as indicated by the black arrows), where the 70° radial line was previously located. The maximum recorded radial angle is now 110° where the full 360° azimuth view is included on a sensor 1500 which could previously only record a maximum radial view of 90°.

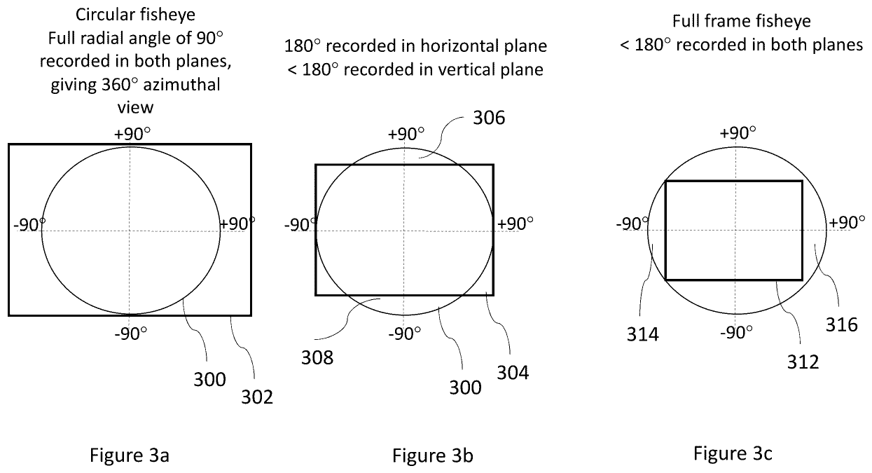

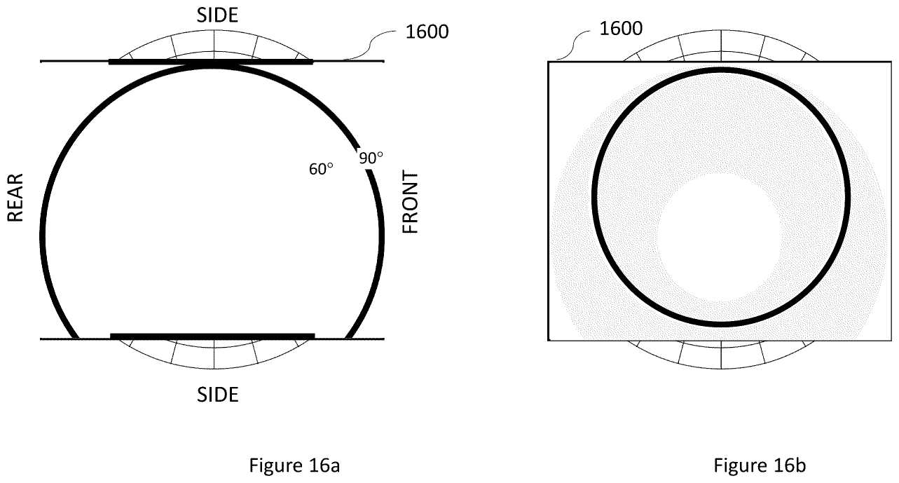

In FIG. 16a a fisheye lens provides a view similar to that shown in FIG. 3b, with a radial angle of 90° recorded in the sensor 1600 in the horizontal plane but less in the vertical plane, see the dark solid line. This is the typical situation when a smaller (lower cost) sensor is used with a fisheye lens. In FIG. 16b a conical wedge prism again provides a 20° radial tilt inwards. The maximum radial view angle is now 110° horizontally and 90° vertically, so one can view a complete 360° azimuthal direction at a radial angle of 90° on the same sensor 1600, the typical situation when a smaller (lower cost) sensor is used. The conical wedge prism thus allows a larger radial viewing angle around a full 360° azimuthal direction to be recorded on a small sensor 1500, with associated cost saving and enhanced capability.

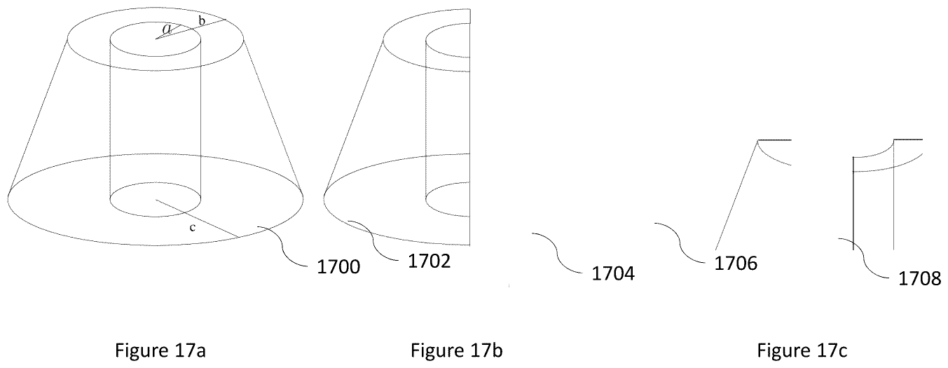

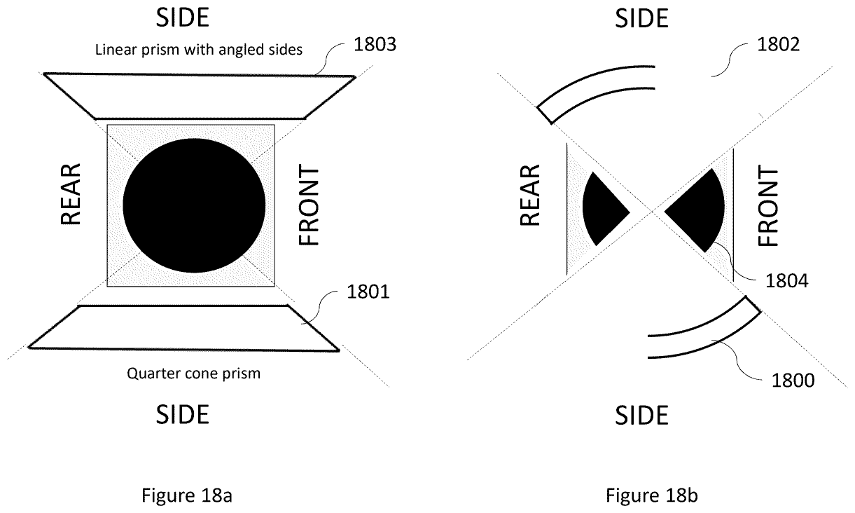

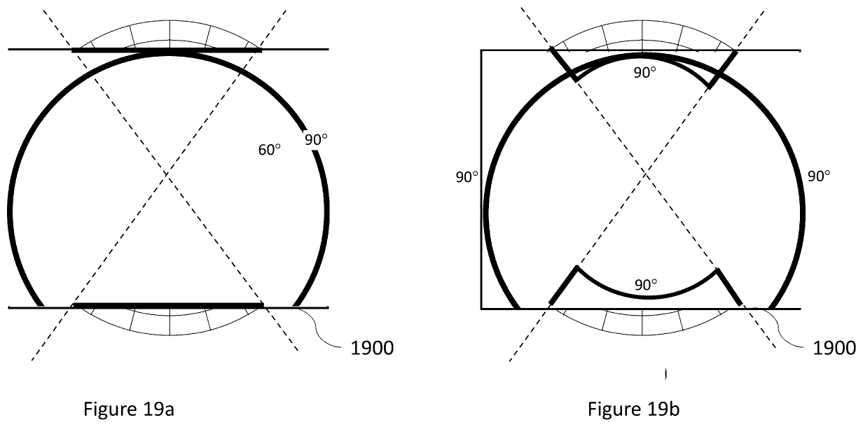

FIG. 17 shows how a conical wedge prism 1700 in FIG. 17a extending over a complete 360° circumference may be split into two separate halves 1702, 1704, each providing 180° of azimuthal view in FIG. 17b, or split into four separate quarters e.g. 1706, 1708, each providing 90° of azimuthal view in FIG. 17c. The quarter conical wedge prisms e.g. 1706, 1708 in FIG. 17c act in the same manner as the linear wedge prisms e.g. 1100 with extended sides in FIGS. 11b and c; each provides an azimuthal view of 90°, but the conical wedge prism may be preferred since it has a uniform lens/prism spacing and alignment. This is also shown in FIG. 18a (linear prizms 1801, 1803 with angled sides) and b (quarter conical wedge prisms 1800, 1802). In FIG. 18b, two such quarter conical wedge prisms 1800, 1802 are located at the sides of a fisheye lens 1804 where the radial view angle is limited to less than 90°—their effect is to only modify the radial view within the 90° of azimuthal view encompassed by the two quarter conical wedge prisms 1800, 1802, leaving the other front and rear 90° quadrants unaffected. Compared to FIG. 19a, which shows a configuration similar to that of FIG. 16a, i.e. no prisms used and a sacrifice in angular range for the vertical direction of the sensor 1900, the use of two quarter conical wedge prisms provides extra flexibility in tailoring from which azimuthal range the radial view is modified, here a maximum view angle is now 110° horizontally and just over 90 degrees vertically, so one views complete 360 degree azimuthal direction at 90 degree to forward direction with the same sensor 1900, FIG. 19b.

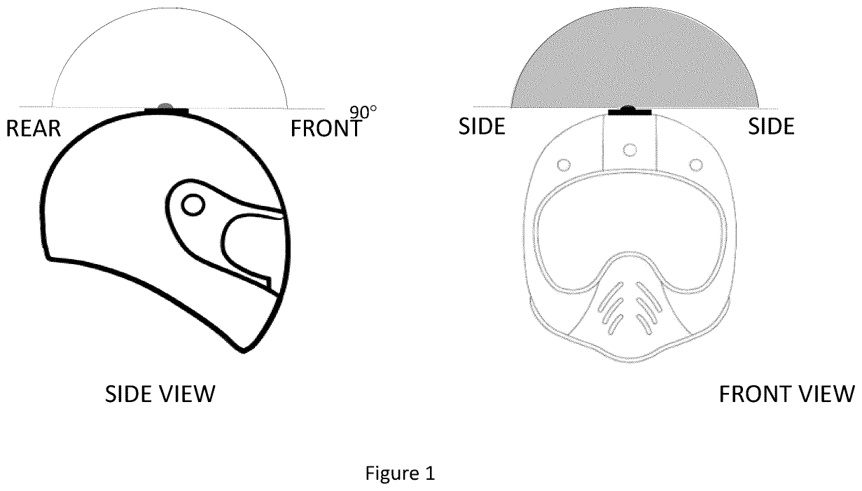

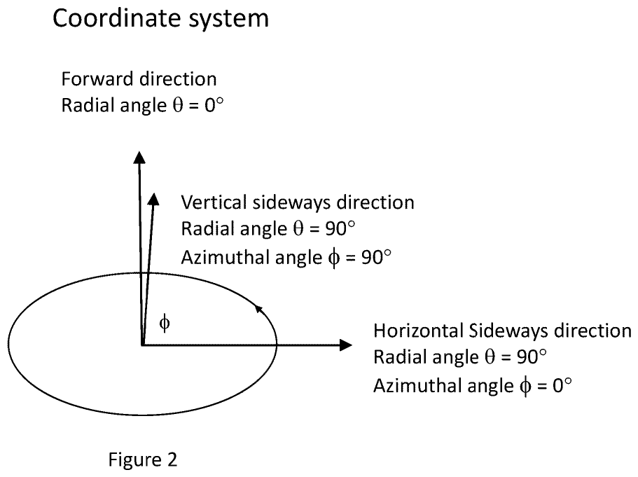

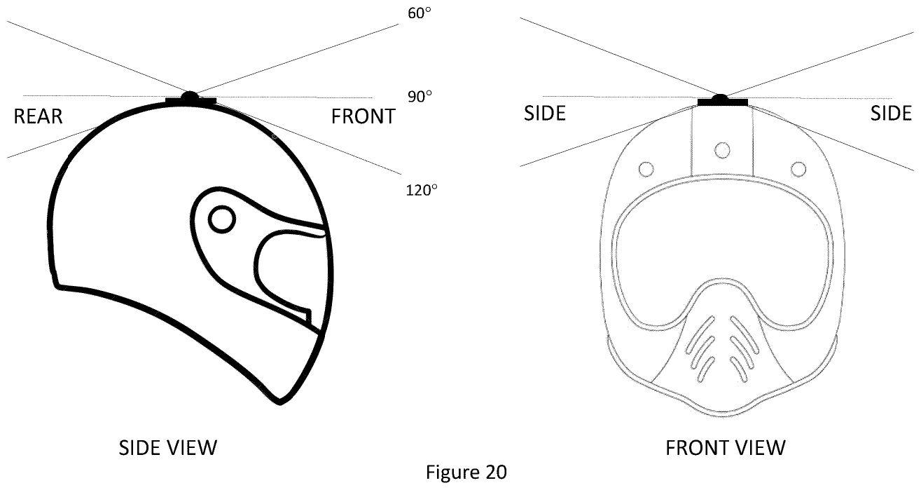

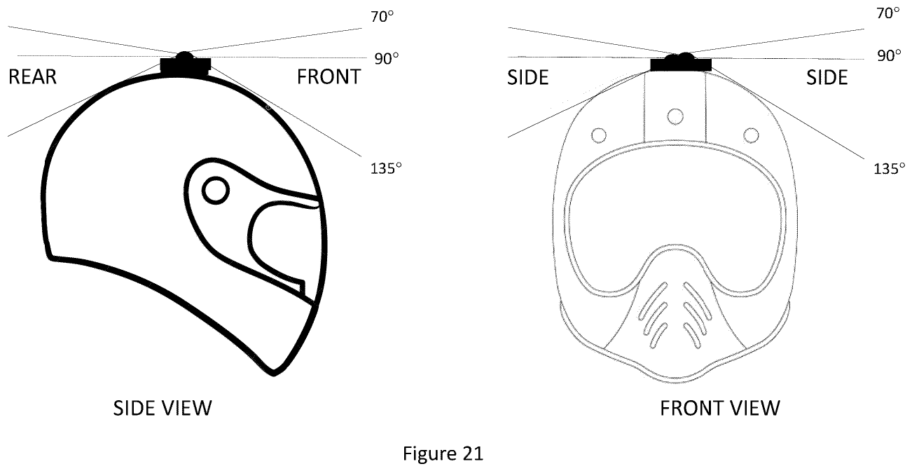

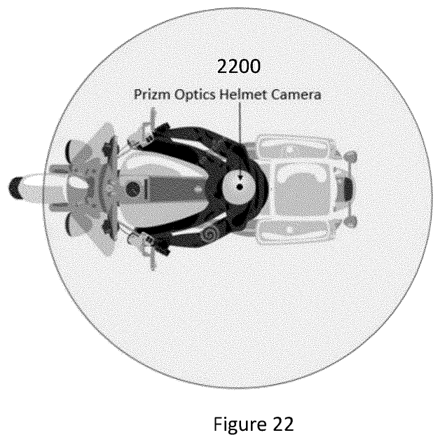

FIG. 20 shows how a conical wedge prism (single, two halves, or 4 quarters) located over the same fisheye lens as used on a motorbike helmet in FIG. 1. It also applies to helmet mounted cameras as used by cyclists, security or military helmets. It provides a complete 360° azimuthal view over a radial angle significantly below and above the horizontal plane of the camera (i.e. azimuthal plane at a 90° radial angle). Typically one wants to view over a range of up to 30° above and below this plane (i.e. radial angles between 60° and 120°). Conical wedge prisms allow this without having to use larger, more expensive sensors and more expensive fisheye lenses to capture a similar maximum FOV, using instead a standard fisheye which typically has a maximum FOV of up to 220°. Hence, an example embodiment can provide a less distorted view utilizing smaller, cheaper sensors to record suitable complete 360° azimuthal views over the required radial angular range. FIG. 21 shows the same geometry but now equipped with a conical wedge prism in the geometry shown in FIG. 12e, which is able to deflect even larger radial angles into the fisheye lens, giving a viewing range from 70° to 135° in this example. FIG. 22 shows a plan view of such a fisheye camera when mounted on a motorcycle helmet 2200, providing 360° surround view on a single sensor.

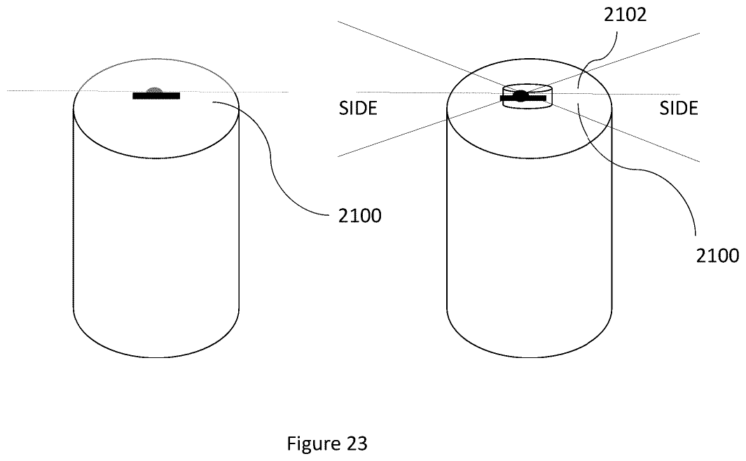

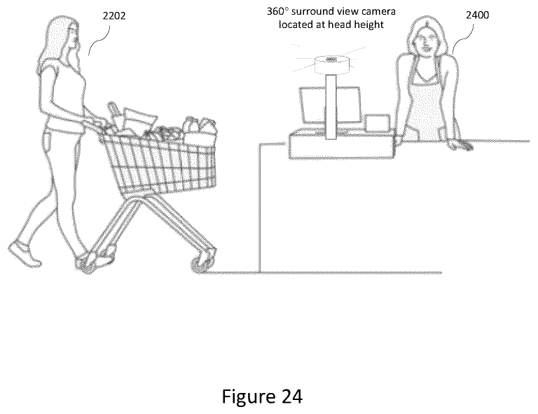

FIG. 23 shows another example of how the fisheye lens 2300 and prism, e.g. conical wedge prism 2302 geometry according to an example embodiment may be used to provide 360° azimuthal surround views for purposes such as videoconferencing when placed in the centre of a large table. Another example is to provide 360° surveillance in public spaces and shops, as shown in FIG. 24, allowing, for example, when mounted close to a shop check out, a cashier 2400 and customers 2402 to be recorded in the same view according to an example embodiment. Again, the preferred requirement is to view typically 30° above and below the horizontal plane of the upwards pointing camera, i.e. θ=60° to 120°. While this may be achieved using an expensive fisheye lens and a large sensor, the use of conical wedge prisms and a standard, low cost fisheye mounted on a small sensor offers a cheaper way to do this, according to an example embodiment. Furthermore, mounting at head height offers the possibility of using computer analytics such as facial recognition over a full surround view, something which is not possible for ceiling mounted cameras as the viewing angle of faces below is too steep.

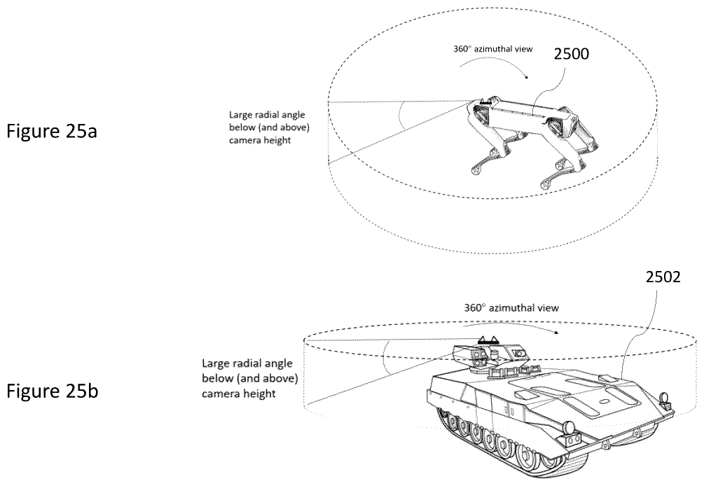

FIG. 25 shows two further example embodiments of the use of e.g. conical wedge prisms in conjunction with standard fisheye lenses and small sensors to provide 360° surround views according to example embodiments, in situations where present solutions involve the use of many cameras to do this. FIG. 25a illustrates one mounted example embodiment on a UAV 2500 (unmanned autonomous vehicle), such as “robot dog”, where it can replace the many cameras needed to generate a similar surround view using cameras with narrower fields of view. The very large radial FOV available using the conical wedge allows large downwards angles (below the height of the camera) to be viewed according to such an example embodiment, so minimizing blind spots around the UAV 2500. FIG. 25b shows a similar arrangement with similar benefits when mounted on a military vehicle 2502 where the driver relies heavily on externally mounted cameras to provide situational awareness. The large number of cameras required to do this can be greatly reduced using a single conical wedge prism camera, according to an example embodiment. For both these example embodiments, it it noted that the central view through the open top of the wedge prism could also be useful, e.g. for aerial surveillance, or it may be blocked, depending on the specific requirements.

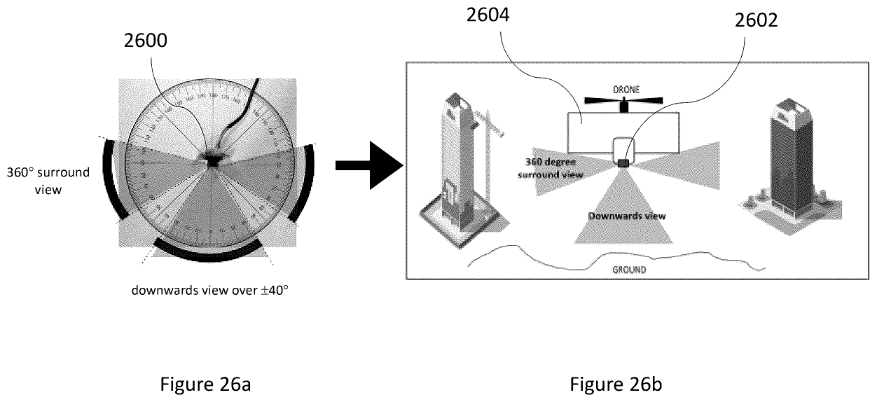

FIG. 26a shows a further example embodiment in which the geometry is flipped so that the fisheye camera with prism, e.g. conical wedge prism(s), at 2600 is pointing directly downwards instead of upwards. The surround view over a wide radial range above and below the height of the camera 2602 provides good situational awareness for a drone 2604 which might be flying outside between buildings for example, as shown FIG. 26b, or inside a building. In such embodiment one preferably can also make use of the central view which does not pass through the prism(s), e.g. the conical wedge prism(s), to provide a downwards view of the ground, using the same sensor as used for the surround view, thus reducing the number of cameras required to record all these different views.

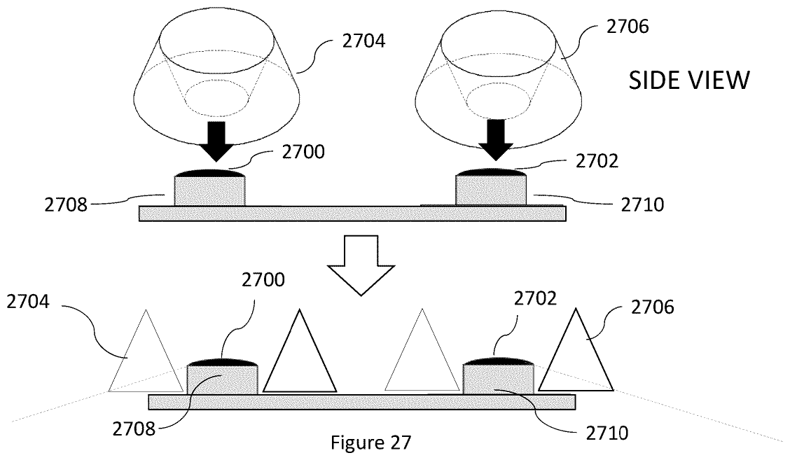

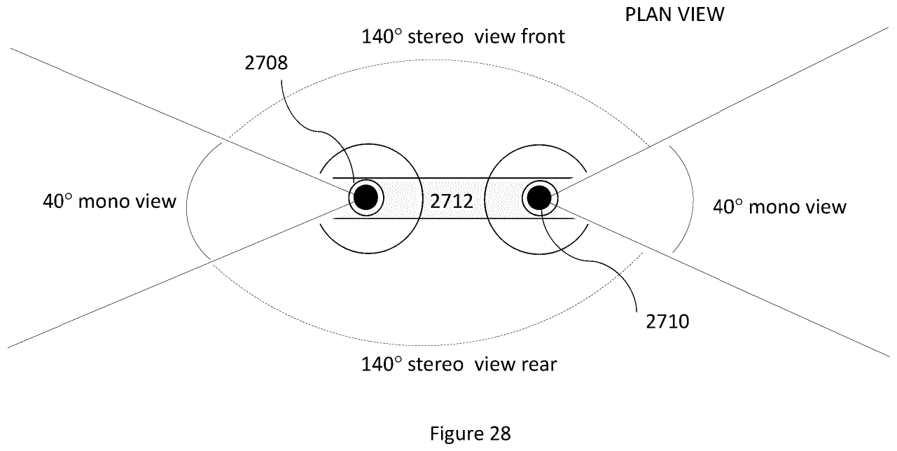

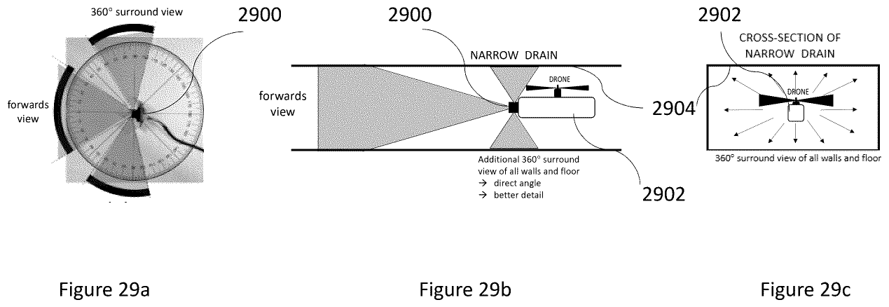

FIGS. 27a and b show further example embodiment in which two adjacent cameras are fitted with fisheye lenses 2700, 2702 and conical wedge prisms 2704, 2706. Each camera 2708, 2710 views over a full azimuthal 360° surround view apart from a small range 2712 along their common axis, so allowing stereo camera operation and the ability to extract depth resolved information over wide angles of e.g. 140° to both the front and rear, FIG. 28.

FIG. 29 shows a further example embodiment in which the optical device 2900 of fisheye camera with prism is oriented horizontally, i.e. parallel to the ground, and mounted on a drone 2902. In this geometry the optical device 2900 may be used for inspection of drain walls and other narrow channels. The forward view is uncovered, see FIG. 29a, and allows the drone 2902 to view and navigate forward in the drain and to see any obstacles present, see FIG. 29b. This is the standard view available on current drone-mounted cameras for drain inspection; the problem with this is that it only allows any problems such as defects, leaks, cracks to be viewed at a shallow forwards angle, and so they are difficult to recognize using computer aided techniques. With conical wedge prism the fisheye camera can now be used to view the drain walls surfaces e.g. 2904 directly as the drone 2902 passes by, see FIG. 29b, rather than at a shallow forward angle, thereby allowing much clearer views of problem areas and allowing them to be easily recognized by computer aided techniques. Furthermore, the 360° surround view achieved allows all the drain walls e.g. 2904 to be viewed at the same time, see FIG. 29c, thereby saving on drone and recording flight time.

Aspects of the systems and methods described herein such as the image capture and processing in the optical device according to example embodiments may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. When received into any of a variety of circuitry (e.g. a computer), such data and/or instruction may be processed by a processing entity (e.g., one or more processors).

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize.

The teachings of the systems and methods provided herein can be applied to other processing systems and methods, not only for the systems and methods described above.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features described for different embodiments, including in the summary section, even if the feature or combination of features is not explicitly specified in the claims or the detailed description of the present embodiments.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

1. An optical device comprising:
a fisheye lens configured to provide a substantially 360° azimuthal angle view with a forward direction at 0° radial angle and with a maximum radial angle θₘ;
a sensor configured to record an image through the fisheye lens; and
one or more wedge prisms disposed adjacent the fisheye lens and each configured such that a ray incident at more than Om radial angle is deflected to be captured through the fisheye lens onto the sensor.

2. The optical device of claim 1, wherein the sensor is rectangular and the one or more wedge prisms are configured such that each of a horizontal angular range and a vertical angular range of the recorded image is +/−θₘ extending over substantially the full horizontal and vertical axes, respectively, of the sensor.

3. The optical device of claim 1, wherein the one or more wedge prisms comprise right angle wedge prisms with a sloped face of the right angle wedge prism facing outwards from the fisheye lens.

4. The optical device of claim 1, wherein the one or more wedge prisms comprise right angle wedge prisms with a vertical face of the right angle wedge prism facing outwards from the fisheye lens.

5. The optical device of claim 1, wherein the one or more wedge prisms comprise isosceles wedge prisms with one of the shallow sloped faces of the isosceles wedge prism facing outwards from the fisheye lens.

6. The optical device of claim 1, wherein the one or more wedge prisms each comprise angled extension portions on either side thereof, and three or more such wedge prisms are disposed around the fisheye lens to direct rays from substantially the full 360° azimuthal angle view through the fisheye lens onto the sensor.

7. The optical device of claim 1, wherein the one or more wedge prisms comprise a conical wedge prism or portions thereof.

8. The optical device of claim 7, wherein the one or more wedge prisms comprise one full conical wedge prism, two half-conical wedge prisms, or four quarter-conical wedge prisms disposed around the fisheye lens to direct rays from substantially the full 360° azimuthal angle view through the fisheye lens onto the sensor.

9. The optical device of claim 1, wherein the one or more wedge prisms comprise two wedge prisms such that rays incident at more than θₘ radial angle from two opposing sides of the substantially full 360° azimuthal angle view are deflected to be captured through the fisheye lens onto the sensor.

10. The optical device of claim 9, wherein the two wedge prisms comprise quarter-conical wedge prisms.

11. A method of extending a field of view of an optical device comprising a fisheye lens configured to provide a substantially 360° azimuthal angle view with a forward direction at 0° radial angle and with a maximum radial angle θₘ, and a sensor configured to record an image through the fisheye lens, the method comprising the step of:
disposing one or more wedge prisms adjacent the fisheye lens, wherein each of the one or more prisms is configured such that a ray incident at more than Om radial angle is deflected to be captured through the fisheye lens onto the sensor.

12. The method of claim 11, wherein the sensor is rectangular and the one or more wedge prisms are configured such that each of a horizontal angular range and a vertical angular range of the recorded image is +/−θₘ extending over substantially the full horizontal and vertical axes, respectively, of the sensor.

13. The method of claim 11, comprising disposing one or more right angle wedge prisms with a sloped face of the right angle wedge prism facing outwards from the fisheye lens.

14. The method of claim 11, comprising disposing one or more right angle wedge prisms with a vertical face of the right angle wedge prism facing outwards from the fisheye lens.

15. The method of claim 11, comprising disposing one or more isosceles wedge prisms with one of the shallow sloped faces of the isosceles wedge prism facing outwards from the fisheye lens.

16. The method of claim 11, wherein the one or more wedge prisms each comprise angled extension portions on either side thereof, and the method comprises disposing three or more such wedge prisms around the fisheye lens to direct rays from the substantially full 360° azimuthal angle view through the fisheye lens onto the sensor.

17. The method of claim 16, wherein the one or more wedge prisms comprise a conical wedge prism or portions thereof.

18. The method of claim 16, comprising disposing one full conical wedge prism, two half-conical wedge prisms, or four quarters-conical wedge prisms around the fisheye lens to direct rays from the substantially full 360° azimuthal angle view through the fisheye lens onto the sensor.

19. The method of claim 11, comprising disposing two wedge prisms such that rays incident at more than θₘ radial angle from two opposing sides of the substantially full 360° azimuthal angle view are deflected to be captured through the fisheye lens onto the sensor.

20. The method of claim 19, wherein the two wedge prisms comprise quarter-conical wedge prisms.
